(19) United States
(12) Patent Application Publication
(10) Pub. No.: US 2005/0179161 A1
(43) Pub. Date: Aug. 18, 2005

(54) Method for manufacturing an embossed mat

(76) Inventor: Yung-Hsin Kao, Chang Hwa (TW)

Correspondence Address: OSTROLENK FABER GERB & SOFFEN, 1180 AVENUE OF THE AMERICAS, NEW YORK, NY, 100368403, US

(21) Appl. No.: 10/779,490

(22) Filed: Feb. 13, 2004

(51) Int. Cl. B29C 59/04

(52) U.S. Cl. 264/139; 264/284; 264/321; 264/322

(57) ABSTRACT

A method for manufacturing an embossed mat includes the steps of (a) preparing a foamed EVA (ethylene vinylacetate) substrate and a patterned cover sheet, (b) heating and softening the foamed EVA substrate, and (c) embossing and cooling the softened foamed EVA substrate and the patterned cover sheet together by stacking and passing the softened foamed EVA substrate and the patterned cover sheet through a nip passage defined by a pair of embossing rollers so as to form the embossed mat.

### BACKGROUND OF THE INVENTION

1. Field of the Invention

This invention relates to a method for manufacturing an embossed mat, more particularly to a method for manufacturing an embossed mat without using of adhesives.

2. Description of the Related Art

For providing aesthetic appeal, a mat made from a foamed substrate, such as an EVA (ethylene vinylacetate) substrate, is laminated with a patterned cover sheet. This kind of mats includes an elastic mat having a wood grain-patterned surface and an embossed anti-slip mat.

The method for manufacturing the abovementioned elastic mat having the wood grain-patterned surface includes the steps of coating a surface of an EVA substrate with an adhesive, and attaching a wood grain-patterned skin layer to the surface of the EVA substrate that is coated with the adhesive. Since the mat thus made has a smooth surface, and since the wood grain-patterned skin layer of the mat has sharp corners, use of the mat can result in slipping or injuries to children and old people.

The method for manufacturing the abovementioned embossed anti-slip mat includes the steps of preparing a foamed EVA substrate and a patterned transfer film, embossing the foamed EVA substrate using a pair of embossing rollers so as to form anti-slip protrusions on a surface of the foamed EVA substrate, coating the surface of the foamed EVA substrate that is formed with the anti-slip protrusions with a hot melt adhesive and drying the hot melt adhesive coated on the surface of the foamed EVA substrate, coating a surface of the patterned transfer film with a hot melt adhesive and drying the hot melt adhesive coated on the surface of the patterned transfer film, attaching the surface of the patterned transfer film with the hot melt adhesive to the surface of the foamed EVA substrate with the hot melt adhesive, hot-pressing the foamed EVA substrate and the patterned transfer film together using a hot press to bond adhesively the foamed EVA substrate to the patterned transfer film, and cutting the embossed anti-slip mat thus made into a desired size.

However, since the patterned transfer film is bound to the foamed EVA substrate through the hot melt adhesive, the patterned transfer film tends to peel off from the foamed EVA substrate if the hot melt adhesive is not evenly distributed between the patterned transfer film and the foamed EVA substrate. In addition, the hot melt adhesive coated respectively on the foamed EVA substrate and the patterned transfer film is required to be dried before bonding of the patterned transfer film to the foamed EVA substrate. It is time-consuming and takes additional costs for drying equipment. More importantly, the hot melt adhesive coated on the foamed EVA substrate tends to accumulate in the recesses among the anti-slip protrusions formed on the surface of the foamed EVA substrate. Consequently, the depth of the recesses among the anti-slip protrusions decreases and thus, results in a reduction in the anti-slip effect of the embossed anti-slip mat.

Therefore, there is still a need in the art to have an embossed mat that can be manufactured more economically and that has an improved anti-slip effect. In order to solve the abovementioned drawbacks encountered in the art, the applicant proposes a method for manufacturing an embossed mat that dispenses with the use of hot melt adhesives and provides an embossed mat having an improved anti-slip effect.

### SUMMARY OF THE INVENTION

According to the present invention, a method for manufacturing an embossed mat includes the steps of: (a) preparing a foamed EVA (ethylene vinylacetate) substrate and a patterned cover sheet; (b) heating and softening the foamed EVA substrate; and (c) embossing and cooling the softened foamed EVA substrate and the patterned cover sheet together by stacking and passing the softened foamed EVA substrate and the patterned cover sheet through a nip passage defined by a pair of embossing rollers so as to form the embossed mat.

### BRIEF DESCRIPTION OF THE DRAWINGS

Other features and advantages of the present invention will become apparent in the following detailed description of the preferred embodiment of the invention, with reference to the accompanying drawings. In the drawings:

FIG. 1 is a block diagram illustrating consecutive steps of the preferred embodiment of a method for manufacturing an embossed mat;

FIG. 2 is a schematic view to illustrate how a softened foamed EVA substrate and a patterned cover sheet are embossed together in the preferred embodiment of this invention; and

FIG. 3 is a cross-sectional view to illustrate the embossed mat obtained from the method of the preferred embodiment.

### DETAILED DESCRIPTION OF THE PREFERRED EMBODIMENT

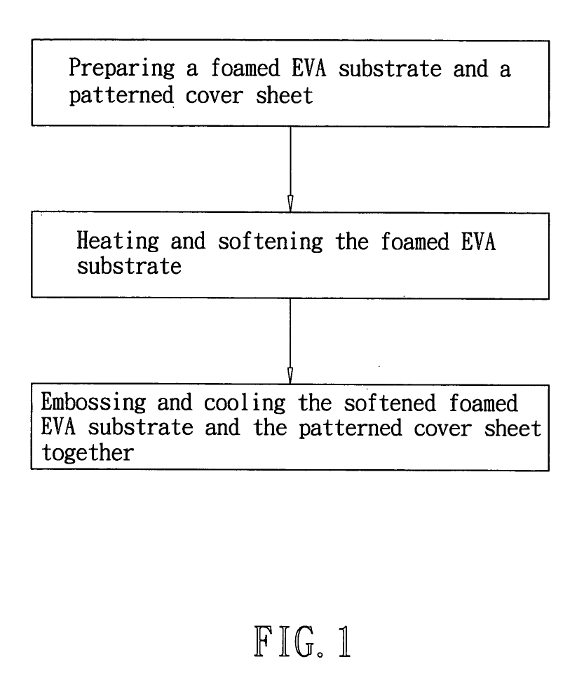

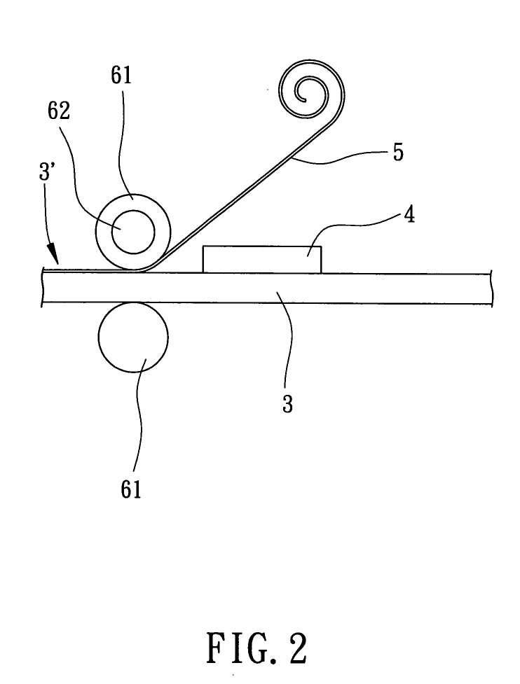

Referring to FIGS. 1 and 2, the preferred embodiment of a method for manufacturing an embossed mat 3′ according to this invention includes the steps of: preparing a foamed EVA (ethylene vinylacetate) substrate 3 and a patterned cover sheet 5; heating and softening the foamed EVA substrate 3; and embossing and cooling the softened foamed EVA substrate 3 and the patterned cover sheet 5 together by stacking and passing the softened foamed EVA substrate 3 and the patterned cover sheet 5 through a nip passage defined by a pair of embossing rollers 61 so as to form the embossed mat 3′.

The foamed EVA substrate 3 normally has a skin layer which is shaved off therefrom prior to the heating and softening operation of the foamed EVA substrate 3. The heating and softening operation of the foamed EVA substrate 3 is conducted using a thermoelectric heating device 4.

In addition, in this embodiment, during the embossing and cooling operation of the softened foamed EVA substrate 3 and the patterned cover sheet 5, at least one of the embossing rollers 61 is cooled so as to permit cooling of the softened foamed EVA substrate 3 and the patterned cover sheet 5 passing therethrough. Preferably, the cooling operation of the embossing rollers 61 is performed by passing a coolant, such as water, through a cooling device 62 that is disposed inside and through the at least one of the embossing rollers 61.

The foamed EVA substrate 3 may be made from foamed EVA copolymers having different colors. As for the patterned cover sheet 5, the detailed descriptions regarding the composition and suitable species of the patterned cover sheet 5 are omitted herein since these are not pertinent to the technical features of this invention and can be readily appreciated by those skilled in the art.

The embossed mat 3′ formed by embossing and cooling the softened foamed EVA substrate 3 and the patterned cover sheet 5 is subsequently cut into a predetermined size depending upon the desired application.

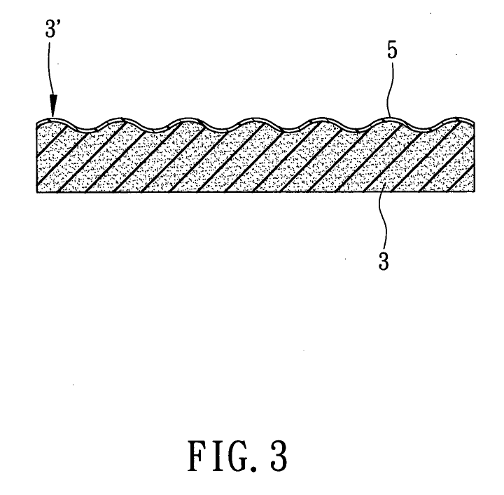

The embossed mat 3′ made according to the abovementioned preferred embodiment is shown in FIG. 3. As shown in FIG. 3, the embossed mat 3′ includes the foamed EVA substrate 3 and the patterned cover sheet 5 that is laminated directly on the foamed EVA substrate 3 by embossing and cooling together with the foamed EVA substrate 3 after the foamed EVA substrate 3 is softened.

In view of the aforesaid, according to the method for manufacturing the embossed mat of this invention, the patterned cover sheet 5 is firmly laminated and fixed to the foamed EVA substrate 3 by embossing them together. Hence, the need for hot melt adhesives as used in the prior art is eliminated, and the aforesaid peeling tendency problem of the patterned transfer film encountered in the prior art is avoided. In addition, when the foamed EVA substrate 3 and the patterned cover sheet 5 are embossed with accompanied cooling, the shrinkage difference between the peripheral region and the central region of the foamed EVA substrate 3 can be minimized so as to improve the laminability and fixability of the patterned cover sheet 5 onto the foamed EVA substrate 3.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A method for manufacturing an embossed mat, comprising the steps of:
(a) preparing a foamed EVA (ethylene vinylacetate) substrate and a patterned cover sheet;
(b) heating and softening the foamed EVA substrate; and
(c) embossing and cooling the softened foamed EVA substrate and the patterned cover sheet together by stacking and passing the softened foamed EVA substrate and the patterned cover sheet through a nip passage defined by a pair of embossing rollers so as to form the embossed mat.

2. The method of claim 1, further comprising removing a skin layer of the foamed EVA substrate prior to the heating operation of step (b).

3. The method of claim 1, wherein the cooling operation of the softened foamed EVA substrate and the patterned cover sheet is conducted by cooling at least one of the embossing rollers during passage of the softened foamed EVA substrate and the patterned cover sheet through the nip passage.

4. The method of claim 3, wherein the cooling operation of said at least one of the embossing rollers is conducted by passing a coolant therethrough.
